(19) United States
(12) Patent Application Publication
(10) Pub. No.: US 2021/0180986 A1
(43) Pub. Date: Jun. 17, 2021

(54) SYSTEMS AND METHOD FOR MAPPING AND REFERENCING PHYSICAL GEOGRAPHIC ADDRESSES TO A DYNAMICALLY LINKED IDENTIFIER

(71) Applicant: Sohail Alavi, Dover, DE (US)

(72) Inventor: Sohail Alavi, Dover, DE (US)

(21) Appl. No.: 17/187,790

(22) Filed: Feb. 27, 2021

Related U.S. Application Data
(63) Continuation of application No. PCT/IB2019/057156, filed on Aug. 26, 2019.
(60) Provisional application No. 62/724,023, filed on Aug. 28, 2018.

(51) Int. Cl. G01C 21/00; G06F 16/29; G06F 21/62; G06F 21/64; G06F 21/31; H04W 4/021

(52) U.S. Cl. CPC G01C 21/3863; G06F 16/29; G06F 21/6245; H04W 4/021; G06F 21/31; G01C 21/3856; G06F 21/645

(57) ABSTRACT

A method for mapping and referencing physical geographic addresses, of a planet, to a dynamically linked identifier, said method comprising: virtually mapping said planet into geographically defined units (“geotiles”); storing data pertaining to each geotile; fetching spatial co-ordinates for each mapped geotile, tagging these spatial co-ordinates to each and every divided mapped geotile; generating an identifier (“owner-identifier”) concerning user-selected geotiles specific to a user to enable a user to generate owner identity concerning said owner-identifier, said owner-identifiers being shareable by its associated user (“owner-user”) only upon being authenticated; generating dynamic links between said owner-identifiers with any number of user-selected geotiles; associating a geotile or a set of geotiles to reside either on a public blockchain or on a private blockchain; associating a user-identifier with user-selected rich data; and displaying, a set of user-selected geotiles along with its associated rich data, upon inputting said owner-identifier.

### RELATED APPLICATIONS

This application claims priority under 35 U.S.C. § 120 to, and is a continuation of, co-pending International Application PCT/IB2019/057156, filed Aug. 26, 2019 and designating the US, which claims priority to US Application 62/724,023, filed Aug. 28, 2018, such US Application also being claimed priority to under 35 U.S.C. § 119. These UN and International applications are incorporated by reference herein in their entireties.

### BACKGROUND

### Field

This invention relates to the field of Geographic Information Systems (GIS). Specifically, this invention relates to systems and method for mapping and referencing physical geographic addresses to a dynamically linked identifier.

GIS has countless applications including but not limited to zoning, street navigation, postal systems etc. This invention shall enable several disruptive innovations in the GIS industry.

There are literally billions of addresses on Earth. Yet, till today, there is no simple, easy, and universal method of handling and/or processing addresses. Indeed, an address remains the most cumbersome element to enter into any form online or offline. Each address, on an average, takes up to an average of 80-100 characters (and often double that in the developing countries). The sheer amount of processing power, and time, that is wasted handling and/or entering addresses is mind boggling.

An address is required by a plurality of nodes in any ecosystem. For example, in a courier ecosystem, for sending out a parcel, an address is first filled out by a mailer each time a courier is sent. Then, each time, this address is filled in by a courier company which services the parcel. Any error in filling out this address by the mailer or the courier company eventually cascades into delays or returns and eventually leads to inefficiencies in the delivery mechanism of the parcel.

In the above example, whether the final delivery person may or may not understand the address is completely discounted. The final delivery person relies on the handwritten or typed out address on the parcel and/or the courier company fed in address relating to the parcel. In either case, the delivery person needs to either know the address by memory or needs to use a further third party application in order to assist in navigating to the address. However, more often than not, this amount of information is not enough for last mile deliveries. Most delivery persons end up calling the recipient of the parcel in order to ask for assistance.

Thus, turn-by-turn navigation is provided by a map application as also by the recipient. This is especially true of developing countries.

In other words, there is tremendous redundancy in the current addressing system: firstly, because of lack of consistent phraseology; secondly, because each node that requires an address needs to feed in the address and later to fetch the fed-in address; and thirdly, because these addresses are never enough for accurate delivery.

According to another example, in the UK alone, there are over 160 Million online credit card transactions and almost every transaction requires a card holder's address to be entered.

There are no known solutions that are universally available that can transform any address into a universal identifier. Furthermore, no known solutions exist where this identifier can be made ubiquitous, updateable, searchable, and customizable.

### SUMMARY

An object of the invention is to provide one single identifier for life, which identifier is updateable in real-time and is configured to be dynamically linked to a plurality of physical addresses.

Another object of the invention is to eliminate vagueness of geo-physical addresses irrespective of the fact that these areas or addresses have been mapped or not.

Yet another object of the invention is to provide a solution that is universally available that can transform any address into a universal identifier.

Still another object of the invention is to provide a solution where an identifier (for an address or a plurality of addresses) can be made ubiquitous, updateable, searchable, and customizable.

### BRIEF DESCRIPTION OF THE DRAWINGS

The invention will now be described in relation to the accompanying drawings, in which:

FIG. 1 illustrates a schematic block diagram of the system; and

FIG. 2 illustrates a schematic diagram concerning the use of the system defined in FIG. 1.

### DETAILED DESCRIPTION

This invention provides systems and method for mapping and referencing physical geographic addresses to a dynamically linked identifier.

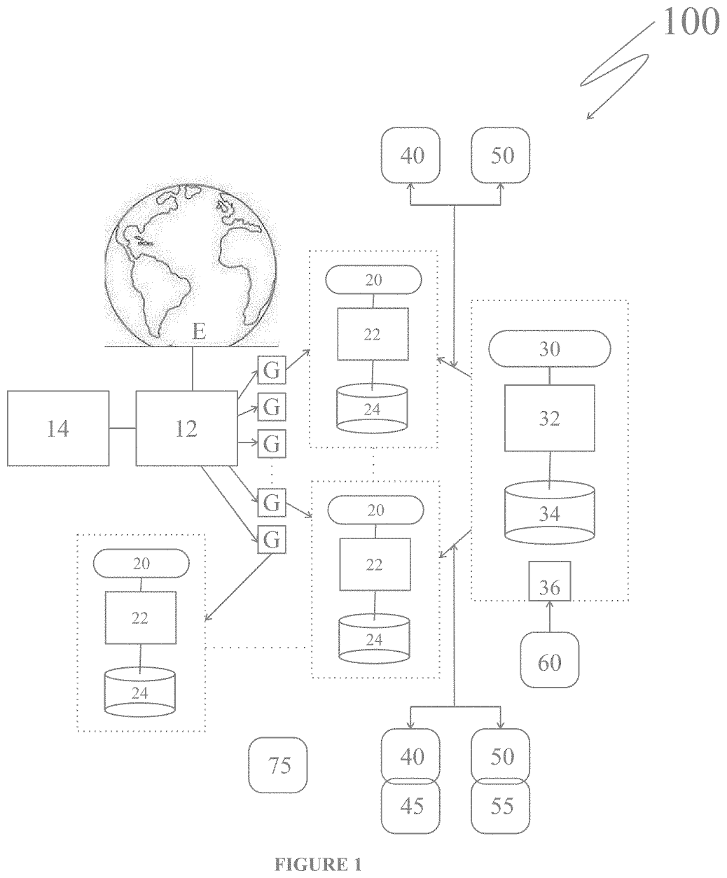

FIG. 1 illustrates a schematic block diagram (100) of the system of this invention.

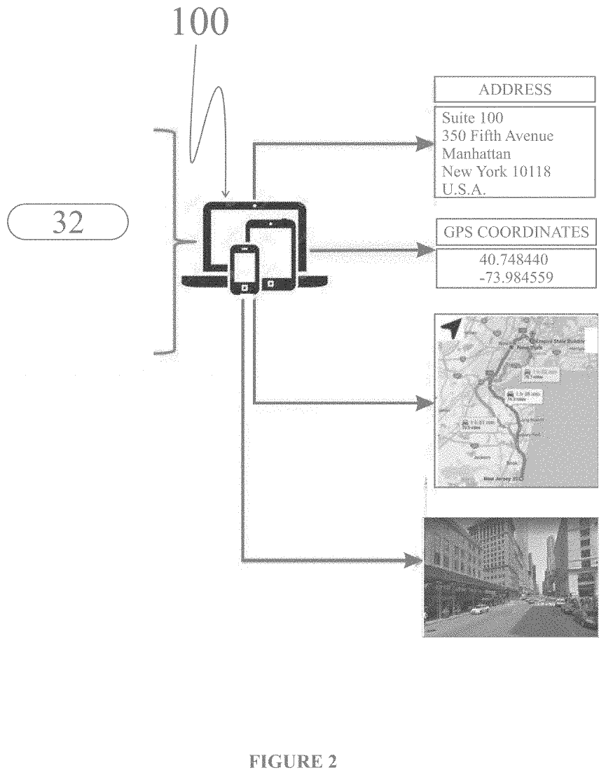

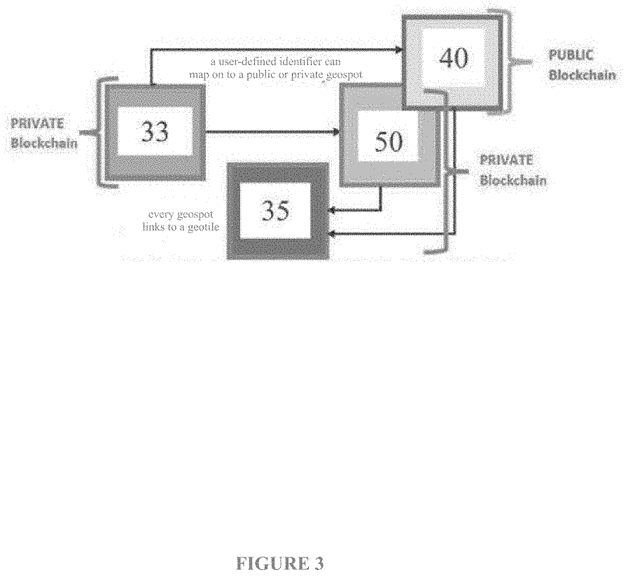

FIG. 2 illustrates a schematic diagram concerning the use of the system defined in FIG. 1.

In at least an embodiment, a virtual mapper (12) is configured to map the planet (E) into geographically defined (and divided) units (herein after called “geotiles”) (G). Typically, the mapping defines 530 trillion geotiles (each unit being 1 square meter). This is visualized on a display (or a Graphical User Interface). The virtual mapper is communicably coupled with a spatial referencing system (14) in order to fetch spatial co-ordinates for each mapped geotile and tags these spatial co-ordinates to each and every divided and mapped geotile. This forms a global data set of spatially mapped geotiles. For each address that is input into this system, a corresponding geotile or a set of geotiles are provided to a user. Similarly, for each spatial coordinate that is input into this system, a corresponding geotile or set of geotiles are provided to a user. In at least an embodiment, the geotiles form a fundamental building block of the system and method of this invention. It is to be understood that any or all of a plurality of systems may be used in order to assign these spatial coordinates in order to increase redundancy.

In at least an embodiment, a first identification mechanism (20) provides a first identifier (22) for each such spatially mapped geotile for future use and reference. Typically, this first identifier may be a computed functional unique and non-duplicable output which uses the spatial co-ordinates per tile. These first identifiers also form a global data set, stored in a first database (24), which can be called/retrieved/used from any communicably coupled node of the system and method of this invention.

In at least an embodiment, a second identification mechanism (30) provides a second user-defined identifier (32) (also called as “owner-identifier”) specific to a user in order to enable a user to generate his or her identity concerning the system and method of this invention. Typically, this second user-defined identifier is also a unique and non-duplicable identifier, in that, once one user generates this identifier for oneself, no other user will be able to use the same identifier. These second identifiers are stored in a secure second database (34) and are allowed to be called by anyone apart from its associated user (hereinafter called “owner-user”) only upon being authenticated by an authentication mechanism (36). The authentication mechanism ensures that data concerning or linked with the second user-defined identifier is available for use or view by any other user only when the owner-user allows authenticates such use. Authentication use, in one embodiment, may be by generating a password and sharing such password. Typically, the authentication mechanism is a time-specific and/or location-specific and/or instance-specific authentication mechanism. In other words, the passwords may be time-specific and/or location-specific and/or instance-specific; meaning that they are activated only for a certain time duration and/or for a certain pre-defined geography and/or for a certain pre-defined instance.

In at least an embodiment, a primary linking mechanism (40) allows a user to link his or her owner-identifier with any number of first identifiers. This creates a dynamic relationship between the owner-identifier and any number of first identifiers.

In at least an embodiment, a primary delinking mechanism (45) allows a user to delink any of the first identifier with his or her owner-identifier.

In at least an embodiment, a secondary linking mechanism (50) allows a user to link her or her owner-identifier with rich data in association with the linked first identifier. An image capturing device or a sensor along with an uploading mechanism can be used for this purpose. This can be a part of the display (or a Graphical User Inteface). Typically, rich data comprises photo files, multimedia files, web content, blog content, weather data, demographic data, or the like data/content/files which are linked. The rich data may be static or auto-updateable from synced resources. Additionally, the rich data may also comprise a text file allow a user to input text data concerning the geotile.

In at least an embodiment, a secondary delinking mechanism (55) allows a user to link her or her owner-identifier with rich data in association with the linked first identifier.

In at least an embodiment, status updating mechanism is provided to a user so that the user can update his or her current location from the set of geotiles associated with the owner identifier on the fly. This mechanism is also part of the display (or a Graphical User Interface). For example, if a user has an owner identifier set as “>Sol”, and associated two addresses: a) Suite 100, 350 Fifth Avenue, Manhattan, N.Y. 10118, U.S.A.; and b) Flat 5F/4, 125 Bell Street, Glasgow G4; and the user currently is at the New York address, he or she can select the first address as a currently live address.

In at least an embodiment, a placeholder defining mechanism can allow a user to select at least a placeholder (hereinafter called “geospot”) for each geotile or set of geotiles that a user wants to associate with a first identifier. This placeholder may be non-view and viewable publicly. In at least an embodiment, only one geospot per user-identified identifier can be selected as a live geospot at any given point in time.

In at least an embodiment, a third linking mechanism allows a user to link his or her owner-identifier with a geospot created by the user.

In at least an embodiment, a third delinking mechanism allows a user to delink his or her owner-identifier with a geospot created by the user.

In at least an embodiment, a rule engine (60) is defined in order to allow a user to define rules concerning each associated geotile or set of geotiles. Referring to the above-address, a user may want to share access of the second address (i.e. Glasgow address) only to his family and may want to share access of the first address (i.e. the New York address) only to delivery companies or couriers, the rule engine allows the user to make such rule and set them per associated geotile or associated set of geotiles.

In at least an embodiment, a retriever mechanism is configured to retrieve an address along with rich data when a user input the owner-identifier subject to authentication. Thus, a retriever mechanism is a node that can be shared in an ecosystem where address fetching is involved and a user can share whether and when to allow or block usage of the owner-identifier.

FIG. 3 illustrates data layers, of the system and method of this invention, as resident using blockchain.

In at least an embodiment, this system and method is deployed on a hybrid blockchain which offers benefits of both public blockchain and private blockchain. A hybrid blockchain consists of a public blockchain (that all users are a part of) and a private blockchain (also referred to as a permissioned network or a private network) restricts participation to those invited by the system and method of this invention. The private blockchain generates a record (hash) of transactions which is stored and verified on the public blockchain. The benefits of a private blockchain include faster transaction speeds, privacy of the data/content and a centralized control over providing access to the blockchain.

Hybrid provides an enterprise-ready blockchain solution that is much better suited to Geomain enabling us to have the flexibility and control over what data is kept private versus shared on a public ledger. This is coupled with the operational needs of faster transaction times, security and auditability features that are not suited to public blockchains.

In at least an embodiment, the registry functions (33) of the system and method of this invention reside on a private blockchain allowing administrators full control of this system and method, other functions (user interaction, data population, linking, and the like) reside on a public blockchain.

The following layer is on the PUBLIC BLOCKCHAIN:

PUBLIC GEOSPOT DATA (40) is the data that users upload about a geospot that they have created and, subsequently, marked as being “public”, allowing anyone to update it, add to it, or comment on it. An example would be where a user visits the Big Ben in London, and marks this geospot as “public”, using a user-tagging module (75), thereby allowing anyone to upload pictures to it and share. Because every geospot links to a geotile, the system and method of this invention is able to create a rich dataset for each geotile populated with publicly available/created data from across all geospots (marked “public”), created by a multiplicity of users, thereby creating an amazingly rich crowd-sourced data set for several locations across the planet. With this quality of (verified) data, the potential to leverage the same by creating heat maps or applying other analytical tools to this rich crowd-sourced data is immense.

The following layer is on the PRIVATE BLOCKCHAIN:

PRIVATE GEOSPOT DATA (50) is the data that users upload about a geospot that they have created and, subsequently, marked as being “private”, using a user-tagging module (75), allowing no one except the user to update it, add to it, or comment on it. These can be homes or workplaces so that only the user can add on to it and share with users of their choice, which sharing may be authentication based as also rule-based.

The TECHNICAL ADVANCEMENT of this invention lies in providing an identifier (for an address or a plurality of addresses) which is ubiquitous, updateable, searchable, and customizable. This provides an instant valid and accurate address for anyone anywhere on the planet. In terms of use of this system and method, it provides a secure environment where a user shares his or her address only in an authenticated manner (by sharing the owner identifier and a code associated with the owner-identifier). This de-risks spam, stalkers, etc. Additionally, last mile problems or last meter data is resourcefully enriched with the system and method of this invention. How to traverse from door to door can be enabled in user-defined text, video, audio and/or images files. For example, when a pizza delivery guy delivers a pizza in a large apartment building, he would, more often than not, struggle to figure out how to get to the right block, then the right lift/elevator, the right floor etc. This system and method of this invention irons these creases by allowing each resident of a condominium to create a set of instructions per his or her own manner.

While this detailed description has disclosed certain specific embodiments of the present invention for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A method for mapping and referencing physical geographic addresses, of a planet, to a dynamically linked identifier, using a computing device, said method comprising the steps of:
virtually mapping said planet (E) into geographically defined (and divided) units (hereinafter called “geotiles”) (G) and storing data pertaining to each geotile;
fetching spatial co-ordinates for each mapped geotile and further tagging these spatial co-ordinates to each and every divided and mapped geotile, and showing at least a portion thereof, through a display;
generating at least an identifier (hereinafter called “owner-identifier”) concerning user-selected geotiles, using said display, specific to a user in order to enable a user to generate his or her owner identity concerning said owner-identifier, said owner-identifiers being shareable by its associated user (hereinafter called “owner-user”) only upon being authenticated;
in response to a user input, generating dynamic links between said owner-identifiers with any number of user-selected geotiles;
in response to a user input, associating a geotile or a set of geotiles to reside either on a public blockchain or on a private blockchain;
in response to a user input, associating a user-identifier with user-selected rich data; and
displaying, in response to a user input, a set of user-selected geotiles along with its associated rich data, upon inputting said owner-identifier.

2. A method for mapping and referencing physical geographic addresses, of a planet, to a dynamically linked identifier, using a computing device, as claimed in claim 1, said method comprising the steps of:
virtually mapping said planet (E) into geographically defined (and divided) units (hereinafter called “geotiles”) (G);
fetching spatial co-ordinates for each mapped geotile and further tagging these spatial co-ordinates to each and every divided and mapped geotile;
invoking a first identifier (22) for each such spatially mapped geotile;
invoking a second user-defined identifier (32) (hereinafter called “owner-identifier”) specific to a user in order to enable a user to generate his or her owner identity concerning said method, said second identifiers being shareable by its associated user (hereinafter called “owner-user”) only upon being authenticated;
allowing a user to link his or her owner-identifier with any number of first identifiers, thereby creating a dynamic relationship between said owner-identifier and any number of first identifiers;
allowing a user to delink any of said first identifiers with his or her owner-identifier;
allowing a user to link her or her owner-identifier with rich data in association with said linked first identifier;
allowing a user to link her or her owner-identifier with rich data in association with the linked first identifier; and
allowing a user to associate a geotile or a set of geotiles to reside either on a public blockchain or on a private blockchain.

3. The method as claimed in claim 2 wherein, said method comprising a step of storing said first identifiers forming a global data set, in a first database (24), which can be called or retrieved or used from any communicably coupled node of said method.

4. The method as claimed in claim 2 wherein, said method comprising a step of storing said second identifiers, in a second database (34).

5. The method as claimed in claim 2 wherein, said system comprising a second database (34) configured to store said second identifiers.

6. The method as claimed in claim 2 wherein, said authentication is a time-specific and/or location-specific and/or instance-specific authentication.

7. The method as claimed in claim 2 wherein, said rich data comprising photo files, multimedia files, web content, blog content, weather data, demographic data, or the like data/content/files which are linked.

8. The method as claimed in claim 2 wherein, said rich data being static or auto-updateable from synced resources.

9. The method as claimed in claim 2 wherein, said rich data comprising a text file allow a user to input text data concerning the geotile.

10. The method as claimed in claim 2 wherein, said method comprising a step of allowing a user to update his or her current location from the set of geotiles associated with the owner-identifier.

11. The method as claimed in claim 2 wherein, said method comprising a step of allowing a user to select at least a placeholder (hereinafter called “geospot”) for each geotile or a set of geotiles that a user wants to associate with said first identifier.

12. The method as claimed in claim 11 wherein, said method comprising a step of allowing a user to link his or her owner-identifier with a geospot created by said user.

13. The method as claimed in claim 11 wherein, said method comprising a step of allowing a user to delink his or her owner-identifier with a geospot created by said user.

14. The method as claimed in claim 11 wherein, said method comprising a step of allowing a user to define rules concerning each associated geotile or set of geotiles.

15. The method as claimed in claim 11 wherein, said method comprising a step of retrieving an address along with rich data when a user input the owner-identifier subject to authentication.

16. A system for mapping and referencing physical geographic addresses, of a planet, to a dynamically linked identifier, using a computing device, said system comprising:
a memory device storing logic and rules for the block chain distributed network; and
a processing device operatively coupled to the memory device, wherein the processing device is configured to execute computer-readable program code to:
virtually mapping said planet (E) into geographically defined (and divided) units (hereinafter called “geotiles”) (G);
fetching spatial co-ordinates for each mapped geotile and further tagging these spatial co-ordinates to each and every divided and mapped geotile;
invoking a first identifier (22) for each such spatially mapped geotile;
invoking a second user-defined identifier (32) (hereinafter called “owner-identifier”) specific to a user in order to enable a user to generate his or her owner identity concerning said method, said second identifiers being shareable by its associated user (hereinafter called “owner-user”) only upon being authenticated;
allowing a user to link his or her owner-identifier with any number of first identifiers, thereby creating a dynamic relationship between said owner-identifier and any number of first identifiers;
allowing a user to delink any of said first identifiers with his or her owner-identifier;
allowing a user to link her or her owner-identifier with rich data in association with said linked first identifier;
allowing a user to link her or her owner-identifier with rich data in association with the linked first identifier; and
allowing a user to associate a geotile or a set of geotiles to reside either on a public blockchain or on a private blockchain.

17. The system as claimed in claim 16 wherein, said system comprising a first database (24) configured to store said first identifiers forming a global data set which can be called or retrieved or used from any communicably coupled node of said system.

18. The system as claimed in claim 16 wherein, said system comprising a second database (34) configured to store said second identifiers.

19. The system as claimed in claim 16 wherein, said authentication mechanism is a time-specific and/or location-specific and/or instance-specific authentication mechanism.

20. The method as claimed in claim 16 wherein, said rich data comprising photo files, multimedia files, web content, blog content, weather data, demographic data, or the like data/content/files which are linked.

21. The method as claimed in claim 16 wherein, said rich data being static or auto-updateable from synced resources.

22. The method as claimed in claim 16 wherein, said rich data comprising a text file allow a user to input text data concerning the geotile.

23. The system as claimed in claim 16 wherein, said system comprising a status updating mechanism provided to a user so that said user can update his or her current location from the set of geotiles associated with the owner-identifier.

24. The system as claimed in claim 16 wherein, said system comprising a placeholder defining mechanism allowing a user to select at least a placeholder (hereinafter called “geospot”) for each geotile or a set of geotiles that a user wants to associate with said first identifier.

25. The system as claimed in claim 24 wherein, said system comprising third linking mechanism allowing a user to link his or her owner-identifier with a geospot created by said user.

26. The system as claimed in claim 24 wherein, said system comprising a third delinking mechanism allows a user to delink his or her owner-identifier with a geospot created by said user.

27. The system as claimed in claim 16 wherein, said system comprising a rule engine (60) defined in order to allow a user to define rules concerning each associated geotile or set of geotiles.

28. The system as claimed in claim 16 wherein, said system comprising a retriever mechanism configured to retrieve an address along with rich data when a user input the owner-identifier subject to authentication.

29. A system for mapping and referencing physical geographic addresses, of a planet, to a dynamically linked identifier, using a computing device, said system comprising:
a virtual mapper (12) configured to map said planet (E) into geographically defined (and divided) units (hereinafter called “geotiles”) (G);
spatial referencing system (14) communicably coupled to said virtual mapper communicably in order to fetch spatial co-ordinates for each mapped geotile and further configured to tag these spatial co-ordinates to each and every divided and mapped geotile;
a first identification mechanism (20) providing a first identifier (22) for each such spatially mapped geotile;
a second identification mechanism (30) providing a second user-defined identifier (32) (hereinafter called “owner-identifier”) specific to a user in order to enable a user to generate his or her owner identity concerning said system, said second identifiers being shareable by its associated user (hereinafter called “owner-user”) only upon being authenticated by an authentication mechanism (36);
a primary linking mechanism (40) allowing a user to link his or her owner-identifier with any number of first identifiers, thereby creating a dynamic relationship between said owner-identifier and any number of first identifiers;
a primary delinking mechanism (45) allowing a user to delink any of said first identifiers with his or her owner-identifier;
a secondary linking mechanism (50) allowing a user to link her or her owner-identifier with rich data in association with said linked first identifier;
a secondary delinking mechanism (55) allowing a user to link her or her owner-identifier with rich data in association with the linked first identifier; and
a user-tagging module (75) configured to allow a user to associate a geotile or a set of geotiles to reside either on a public blockchain or on a private blockchain.

30. The system as claimed in claim 29 wherein, said system comprising a first database (24) configured to store said first identifiers forming a global data set which can be called or retrieved or used from any communicably coupled node of said system.

31. The system as claimed in claim 29 wherein, said system comprising a second database (34) configured to store said second identifiers.

32. The system as claimed in claim 29 wherein, said authentication mechanism is a time-specific and/or location-specific and/or instance-specific authentication mechanism.

33. The method as claimed in claim 29 wherein, said rich data comprising photo files, multimedia files, web content, blog content, weather data, demographic data, or the like data/content/files which are linked.

34. The method as claimed in claim 29 wherein, said rich data being static or auto-updateable from synced resources.

35. The method as claimed in claim 29 wherein, said rich data comprising a text file allow a user to input text data concerning the geotile.

36. The system as claimed in claim 29 wherein, said system comprising a status updating mechanism provided to a user so that said user can update his or her current location from the set of geotiles associated with the owner-identifier.

37. The system as claimed in claim 29 wherein, said system comprising a placeholder defining mechanism allowing a user to select at least a placeholder (hereinafter called “geospot”) for each geotile or a set of geotiles that a user wants to associate with said first identifier.

38. The system as claimed in claim 37 wherein, said system comprising third linking mechanism allowing a user to link his or her owner-identifier with a geospot created by said user.

39. The system as claimed in claim 37 wherein, said system comprising a third delinking mechanism allows a user to delink his or her owner-identifier with a geospot created by said user.

40. The system as claimed in claim 29 wherein, said system comprising a rule engine (60) defined in order to allow a user to define rules concerning each associated geotile or set of geotiles.

41. The system as claimed in claim 29 wherein, said system comprising a retriever mechanism configured to retrieve an address along with rich data when a user input the owner-identifier subject to authentication.
